(19) United States
(12) Patent Application Publication
(10) Pub. No.: US 2020/0099628 A1
(43) Pub. Date: Mar. 26, 2020

(54) TRAFFIC RATE LIMITING FOR VMs WITH MULTIPLE VIRTUAL FUNCTIONS

(71) Applicant: Intel Corporation, Santa Clara, CA (US)

(72) Inventors: Neerav Parikh, Hillsboro, OR (US); Nrupal Jani, Hillsboro, OR (US)

(73) Assignee: Intel Corporation, Santa Clara, CA (US)

(21) Appl. No.: 16/697,666

(22) Filed: Nov. 27, 2019

Related U.S. Application Data
(60) Provisional application No. 62/773,153, filed on Nov. 29, 2018.

(51) Int. Cl. H04L 12/863; G06F 9/455; H04L 12/815; H04L 29/12; H04L 29/08

(52) U.S. Cl. CPC H04L 47/6255; G06F 9/45558; G06F 2009/45583; H04L 61/1552; H04L 67/1097; H04L 47/225

(57) ABSTRACT

The present disclosure is directed to systems and methods for rate limiting network traffic generated by virtual machines (VMs) having multiple attached SR-IOV virtual functions. The network interface circuitry includes a plurality of offload circuits, each performing operations associated with a specific VF. Each VM attached to network interface circuitry is assigned a unique identifier. The unique identifier associated with a VM is inserted into the header of data packets originated by the VM. The packets are queued using a dedicated memory queue assigned to the VM. The aggregate data transfer rate for the VM is determined based upon counting the data packets originated by the VM and processed across the plurality of offload circuits. If the aggregate data transfer rate exceeds a data transfer rate threshold, traffic control circuitry limits the transfer of data packets from the memory queue associated with the VM to the plurality of offload circuits.

### TECHNICAL FIELD

The present disclosure relates to data processing, and more particularly, limiting network traffic in virtual machines having multiple single root I/O virtualization functions.

### BACKGROUND

Currently, solutions exist to rate limit a specific single root I/O virtualization (SR-IOV) function that generates local area network (LAN) and remote direct memory access (RDMA) traffic for a particular virtual machine (VM). These solutions are effective as long as only a single SR-IOV function generates traffic toward the network. However, with increasing functionality moving into VMs in cloud and communications environments, there are many deployments where a given VM may require multiple SR-IOV functions capable of generating network traffic. Present network interface card (NIC) solutions provide a virtual station interface (VSI) per SR-IOV function and provide VSI based rate limiting and/or provide rate limiting to some aggregation of such VSIs. In Linux operating system (O/S) environments while each virtual function (VF) may be individually rate limited via iproute2 commands, there is no VM level rate limiting method to rate limit multiple VFs assigned to a particular VM. The current solution requires all of the traffic from a particular VM (network and/or storage) either use the same VSI or all the VSIs must belong to a common hierarchy.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 depicts an illustrative system that includes a plurality of host devices coupled to network interface circuitry that includes a plurality of offload circuits, traffic control circuitry, and control plane circuitry that limit the flow of data to the offload circuits from each of a plurality of virtual machines executed by the hosts, in accordance with at least one embodiment described herein;

FIG. 2 depicts an input/output diagram of illustrative queue circuitry that includes a plurality of queue circuits, in accordance with at least one embodiment described herein;

FIG. 3 depicts an input/output diagram of illustrative traffic control circuitry that includes the data store and one or more counter circuits, in accordance with at least one embodiment described herein;

FIG. 4 depicts an input/output diagram of illustrative control plane circuitry that includes the data store and unique identifier generation circuitry, in accordance with at least one embodiment described herein;

FIG. 5 is a high-level logic flow diagram of an illustrative method of the control plane circuitry creating and associating a unique identifier with a VM upon instantiation of the VM, in accordance with at least one embodiment described herein;

FIG. 6 is a high-level logic flow diagram of an illustrative method of detecting the attachment of SR-IOV virtual functions (VFs) to a newly instantiated VM, in accordance with at least one embodiment described herein;

FIG. 7 is a high-level logic flow diagram of an illustrative method of configuring the network interface circuitry hardware resources for use by the VM, in accordance with at least one embodiment described herein;

FIG. 8 is a high-level logic flow diagram of an illustrative method of determining a data transfer rate limit for the VM, in accordance with at least one embodiment described herein; and

FIG. 9 is a high-level logic flow diagram of an illustrative method of rate limiting the data flow from a VM through the offload circuits, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

The present disclosure is directed to systems and methods for rate limiting network traffic for virtual machines (VMs) having multiple SR-IOV functions. More specifically, the present disclosure provides systems and methods that uniquely identify each virtual machine across multiple hosts. Further, the systems and methods disclosed herein provide the capability for control plane circuitry and/or software to program SmartNIC hardware to apply rate limits for each virtual machine. The systems and methods disclosed herein thus beneficially permit the control plane circuitry to flexibly assign SR-IOV functions regardless of their type (LAN or storage) and VSI hierarchy for any virtual machine. Advantageously, the systems and methods disclosed herein do not rely upon a specific VSI or group of VSIs associated with a VM, and instead track the information of all of the SR-IOV VFs on a per-host/per-VM basis.

The systems and methods disclosed herein include network interface circuitry that includes control plane circuitry to assign a unique identifier to each of a plurality of virtual machines coupled to the network interface circuitry. The control plane circuitry includes one or more data stores, data structures, data tables, or databases that includes information representative of the unique identifier associated with each respective one of the plurality of virtual machines. Queue circuitry includes a plurality of memory queues, each of the plurality of memory queues to receive data from a respective one of the plurality of virtual machines. Data from the memory queues includes the unique identifier associated with the VM originating the data. The data from each queue is routed to one of a plurality of offload circuits (e.g., LAN/RDMA offload circuitry; storage offload circuitry; encryption offload circuitry; or accelerator offload circuitry. Traffic control circuitry receives the output from the plurality of offload circuits and routes the data to one of a plurality of ports for communication across one or more external networks. The traffic control circuitry monitors the aggregate data rate across all of the offload circuits for each of the plurality of virtual machines. The traffic control circuity includes one or more data stores, data structures, data tables, or databases that include data representative of a maximum aggregate data rate for each respective one of the plurality of virtual machines. The traffic control circuitry controls or otherwise limits the flow of data from each of the plurality of memory queues based on the maximum aggregate data rate from the virtual machine associated with the respective memory queue.

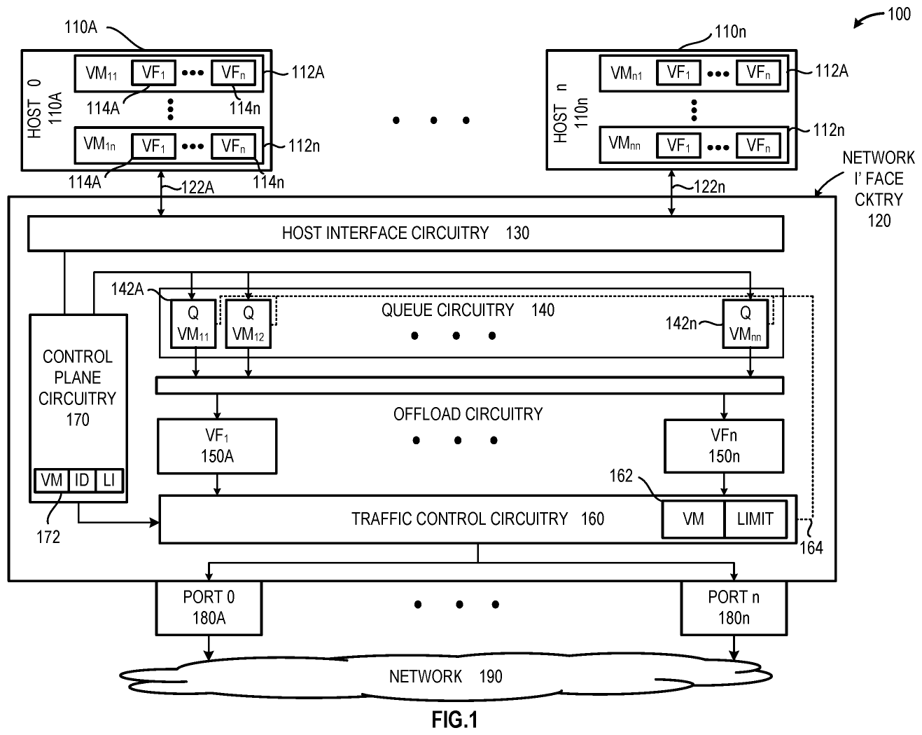

FIG. 1 depicts an illustrative system 100 that includes a plurality of host devices 110A-110n (collectively, “hosts 110”) coupled to network interface circuitry 120 that includes a plurality of offload circuits 150A-150n (collectively, “offload circuits 150”), traffic control circuitry 160, and control plane circuitry 170 that limit the flow of data to the offload circuits 150 from each of a plurality of virtual machines 112A-112n (collectively, “VMs 112”) executed by the hosts 110, in accordance with at least one embodiment described herein. In embodiments, the network interface circuitry 120 includes host interface circuitry 130 to receive data from each of the plurality of virtual machines 112 via a bus 122A-122n (collectively, “buses 122”), such as a PCIe bus. In embodiments, the network interface circuitry 120 also includes queue circuitry 140 having a plurality of memory queues 142A-142n (collectively, “memory queues 142”). Each of the plurality of memory queues 142A-142n receives data from a respective one of the plurality of virtual machines 112A-112n. Each of the plurality of VMs 112 is associated with one or more virtual functions 114A-114n (collectively, “VFs 114”). In embodiments, the operations and/or data manipulations associated with each of the plurality of VFs 114A-114n are performed by a respective one of the offload circuits 150A-150n.

In operation, the control plane circuitry 170 generates and assigns a unique identifier with each VM 112 upon instantiation of the VM. In embodiments, the control plane circuitry 170 stores or otherwise retains information and/or data representative of the association between the VM 112 and the unique identifier assigned to the respective VM using one or more data stores, data structures, data tables, or databases 172. In embodiments, the control plane circuitry 170 may autonomously determine the maximum data rate for each of some or all of the plurality of VMs 112. In embodiments, the control plane circuitry 170 dynamically determines the maximum data rate for each of the plurality of VMs 112. In embodiments, the control plane circuitry 170 may determine a maximum data transfer rate between each of the VMs 112 and a network 190 based upon one or more factors such as a quality of service (QoS) associated with a respective VM 112, network loading, and similar.

The control plane circuitry 170 may communicate to the traffic control circuitry 170 some or all of the information and/or data including the unique identifiers assigned to each of the plurality of VMs 112 and the maximum data transfer rate for each respective one of the plurality of VMs 112. In such embodiments, the traffic control circuitry 160 stores or otherwise retains information and/or data representative of the association between the VM 112 and the maximum data transfer rate for the respective VM using one or more data stores, data structures, data tables, or databases 162. The traffic control circuitry 160 then counts, monitors, assesses, or otherwise determines the data transfer rate between each of the plurality of VMs 112 and one or more network ports 180A-180n (collectively, “ports 180”). If the data transfer rate associated with a VM 112 exceeds the defined maximum data transfer rate for that VM, the traffic control circuitry 160 restricts, throttles, or halts the transfer of data from the respective VM 112 to the offload circuits 150. For example, in some embodiments, the traffic control circuitry 160 may halt the transfer of data from the memory queue 140 associated with the respective VM 112 to the offload circuits 150, thereby exerting a “backpressure” on the data flow from the respective VM 112.

The host devices 110 may include any number and/or combination of processor-based devices capable of executing a hypervisor or similar virtualization software and instantiating any number of virtual machines 112A-112n. In at least some embodiments, some or all of the host devices 110 may include one or more servers and/or blade servers. The host devices 110 include one or more processors. The one or more processors may include single thread processor core circuitry and/or multi-thread processor core circuitry. In embodiments, upon instantiation of a new virtual machine 112 on a host device 110 the host device creates an I/O memory management unit (IOMMU) domain that maps virtual memory addresses for use by the VM 112 to physical memory addresses in the host 110. This domain information is received by the control plane circuitry 170 and provides the indication of the instantiation of a new VM 112 used by the control plane circuitry 170 to assign the unique identifier to the VM 112.

Each of the hosts 110, and consequently each of the VMs 112 executed by the host 110, communicates with the network interface circuitry 120 via one or more communication buses 122. In embodiments, each of the hosts 110 may include a rack-mounted blade server and the one or more communication buses 122 may include one or more backplane buses 122 disposed at least partially within the server rack. The network interface circuitry 120 includes host interface circuitry 130 to receive data transfers from the hosts 110. In embodiments, the network interface circuitry 120 may include a rack-mounted network interface blade containing a network interface card (NIC) or a SmartNIC that includes the plurality of offload circuits 150. Data transferred from the VMs 112 instantiated on the hosts 110 may be transferred using any format and may include data transferred in packets or similar logical structures. In embodiments, the packets include data, such as header data, indicative of the VM 112 that provided the data and/or originated the packet. Each data packet transferred from each VM 112 to the network interface circuitry 120 is associated with the unique identifier assigned by the control plane circuitry 170 to the respective VM 112 originating the data. In embodiments, the control plane circuitry 170 inserts the unique identifier associated with the originating VM 112 as metadata into data packet prior to transferring the data packet to the memory queue 142 associated with the respective VM 112. Thus, using the unique identifier, each data packet is directed into the memory queue 142 associated with the VM 112 that originated data packet. Each of the plurality of memory queues 142 may have the same or a different data and/or packet storage capacity. Although depicted in FIG. 1 as a single memory queue 142A-142n for each respective one of the VMs 112A-112n (i.e., the number of memory queues 142 equals the number of VMs 112), in other embodiments, a single memory queue 142A-142n for each respective one of the VMs 112A-112n may exist for each of the offload circuits 150 (i.e., the number of memory queues 142 equals the number of

VMs 112 multiplied by the number of offload circuits 150 included in the network interface circuitry 150. Each of the plurality of memory queues 142 holds, stores, retains, or otherwise contains data generated by and transferred from a single VM 112. Thus, the ability to limit the data transfer rate from each VM 112 is beneficially individually controllable by limiting or halting the flow of data though the memory queue(s) 142 associated with the respective VM 112. Such control of data flow from the VM 112 to the memory queue 142 may be accomplished by limiting or halting the transfer of data from the respective memory queue(s) 142 to the offload circuits 150 or by limiting or halting the transfer of data from the respective VM 112 to the memory queue(s) 142.

Data flows from the memory queues 142 to one of the plurality of offload circuits 150A-150n. Each of the offload circuits 150 corresponds to a virtual function (VF) mappable to all or a portion of the plurality of VMs 112. Thus, each of the offload circuits 150 is available for use by a particular VM 112 only if the host 110, or the hypervisor executing on the host 110, has associated the respective VM 112 with the VF performed by the respective offload circuit 150. Example virtual functions provided by the offload circuits 150A-150n include but are not limited to: local area network (LAN) communications; remote direct memory access (RDMA); non-volatile data storage; cryptographic functions; and programmable acceleration functions. The offload circuits 150 thus provide the capability for VMs 112 to “offload” network related processing from the host CPU. The output data generated by the offload circuits 150 includes the unique identifier associated with the originating VM 112.

The output data from the offload circuits 150 flows to the traffic control circuitry 160. In embodiments, the control plane circuitry 170 may provide all or a portion of the traffic control circuitry 160. In embodiments, the traffic control circuitry 160 and the control plane circuitry 170 may include separate circuits between which information and/or data, such as VM unique identifiers and data transfer rate limits associated with each VM 112 are communicated or otherwise transferred on a periodic, aperiodic, intermittent, continuous, or event-driven basis. The traffic control circuitry 160 includes one or more data stores, data structures, data tables, or databases 162 used to store information and/or data representative of the respective data transfer rate limit for each of the plurality of VMs 112. In embodiments, the traffic control circuitry 160 may include any number of timers and/or counters useful for determining the respective data transfer rate for each of the plurality of VMs 112. The traffic control circuitry 170 also includes any number of electrical components, semiconductor devices, logic elements, and/or comparators capable of determining whether each of the plurality of VMs 112 has exceeded their associated data transfer rate limit.

The traffic control circuitry 160 generates one or more control output signals 164 used to individually control the flow of data through each of the plurality of memory queues 142A-142n. The traffic control circuitry 160 selectively throttles, controls, limits, or halts the flow of data through each memory queue 142 when the VM 112 associated with the respective memory queue 142 meets or exceeds the data transfer rate limit for included in the data store 162. In embodiments, the one or more control output signals 164 may throttle, control, limit, or halt the flow of data from the VM 112 to the respective queue 142. In other embodiments, the one or more control output signals 164 may throttle, control, limit, or halt the flow of data from the respective queue 142 to the plurality of offload circuits 150A-150n. In yet other embodiments, the control output signal 164 may be communicated to the control plane circuity 170 and the control plane circuitry 170 may halt the transfer of data from the respective VM 112 to the memory queue 142. Output data from the plurality of offload circuits 150A-150n flows through one or more of the plurality of ports 180A-180n to the network 190. The ports 150 may include any number and/or combination of wired and/or wireless network interface circuits. For example, the ports 150 may include one or more IEEE 802.3 (Ethernet) compliant communications interfaces and/or one or more IEEE 802.11 (WiFi) compliant communications interfaces.

The control plane circuitry 170 includes any number and/or combination of electronic components, semiconductor devices, or logic elements capable of generating the unique identifier associated with each of the plurality of VMs 112 upon instantiation of the respective VM; inserting or otherwise associating the unique identifier with data transferred from each of the plurality of VMs 112 to the memory queues 142A-142n (e.g., placing the unique identifier associated with the VM in a packet header prior to transferring the packet to the memory queues 142); and, in at least some embodiments, providing to the traffic control circuitry 160 data transfer rate limits for each respective one of the plurality of VMs 112.

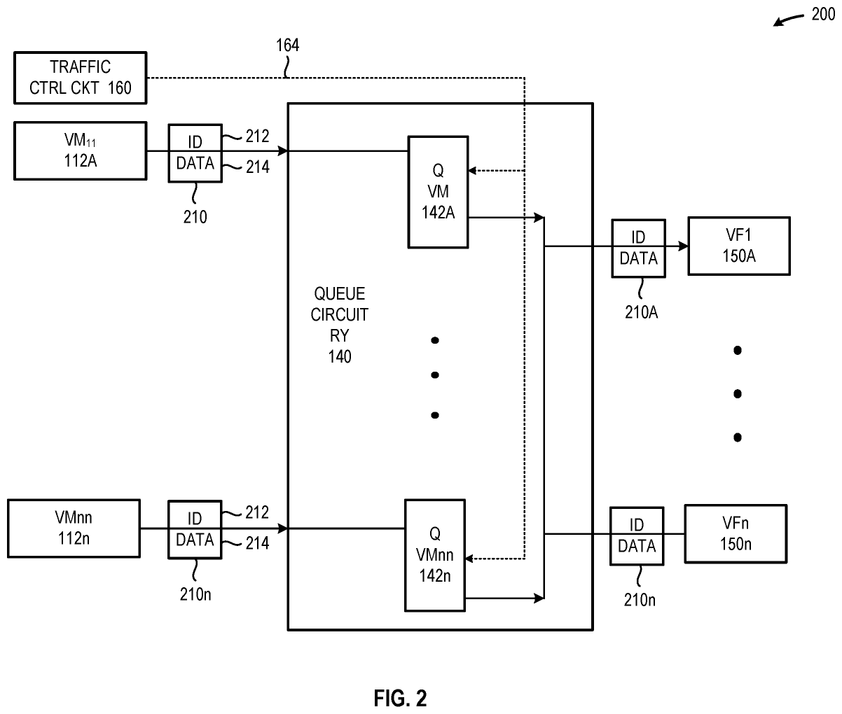

FIG. 2 depicts an input/output diagram of illustrative queue circuitry 140 that includes a plurality of memory queues 142A-142n, in accordance with at least one embodiment described herein. As depicted in FIG. 2, data packets 210A-210n from each of the plurality of VMs 112A-112n are transferred to the memory queue 142 associated with the respective VM 112. In embodiments, upon arrival at the memory queue 142, each packet 210 includes a header that includes information and/or data representative of the unique identifier 212 assigned to the VM 112 by the control plane circuitry 170. Each packet 210 also includes data 214 provided by the VM 112 to the offload circuitry 150. The packets 210 are stored or otherwise retained by the memory queue 142 associated with VM 112 from which the data originated. Data packets flow from the memory queues 142 to the offload circuit 150 that provides the virtual functionality requested by the VM 112 from which the data originated.

As depicted in FIG. 2, each of the plurality of memory queues 142A-142n receives a control output signal 164 generated by the traffic control circuitry 160. The control output signal 164 selectively throttles, controls, limits, or halts the flow of data through each memory queue 142 when the VM 112 associated with the respective memory queue 142 meets or exceeds the data transfer rate limit for included in the data store 162. In embodiments, the flow of data packets 210 from the memory queue 142 to some or all of the offload circuits 150A-150n is selectively halted by the traffic control circuitry 160 to maintain the data transfer rate from a VM 112 at or below the data transfer rate limit associated with the respective VM. In such instances, the VM 112 may continue to send packets to the memory queue 142 until the memory queue fills. At that point, the “backpressure” exerted by the now filled queue will halt the flow of packets from the VM 112 to the memory queue 142. In embodiments, the traffic control circuitry 160 may restart or resume the flow of data packets 210 from the queue 142 in a manner that maintains the data transfer rate from the VM 112 to the network 190 at or below the data transfer rate limit associated with the respective VM. Upon restart or resumption of data packet flow from the memory queue 142, the “backpressure” on the VM 112 is relieved or released and the flow of data packets from the VM 112 to the memory queue 142 resumes. In other instances, the traffic control circuitry 160 may selectively halt the flow of data packets 210 from a VM 112 to the memory queue 142 when the data transfer rate from the respective VM to the network 190 meets or exceeds the data transfer rate limit for included in the data store 162.

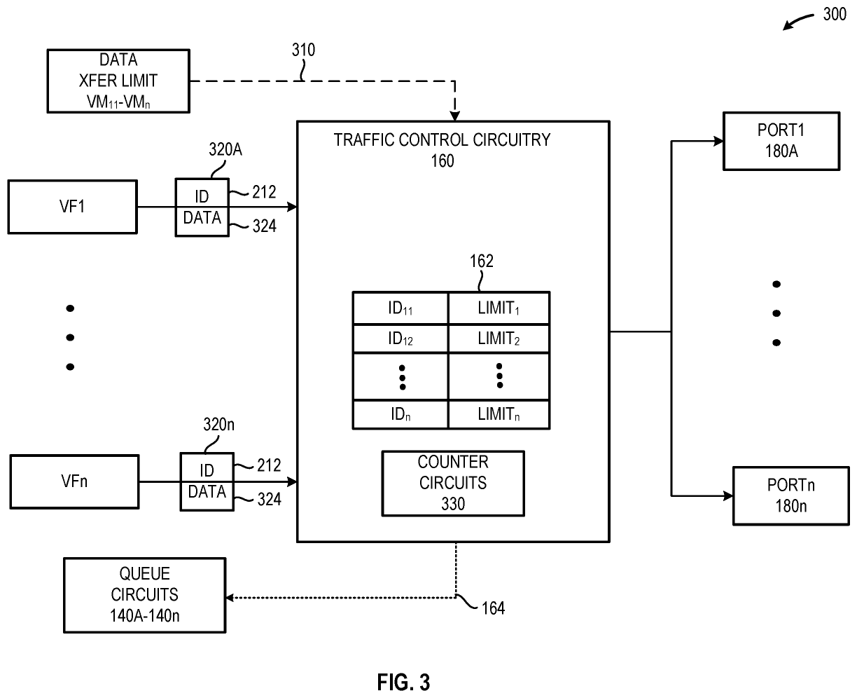

FIG. 3 depicts an input/output diagram of illustrative traffic control circuitry 160 that includes the data store 162 and one or more counter circuits 330, in accordance with at least one embodiment described herein. As depicted in FIG. 3, the offload circuits 150A-150n perform one or more operations and/or transactions on the data packets provided by the plurality of VMs 112 to provide output data packets 320A-320n that include a header that includes information and/or data representative of the unique identifier 212 assigned to the VM 112 by the control plane circuitry 170. Each packet 320 also includes output data 324 provided by the offload circuitry 150 to one or more ports 180A-180n.

In embodiments, the traffic control circuitry 160 may receive information and/or data 310 representative of one or more data transfer rate limits. In embodiments, the traffic control circuitry 160 may receive information and/or data 310 representative of a respective data transfer rate limit for each of the plurality of VMs 112. In other embodiments, the traffic control circuitry 160 may autonomously determine a respective data transfer rate limit for each of the plurality VMs 112 based on information and/or data obtained by the traffic control circuitry 160. The traffic control circuitry 160 includes one or more data stores, data structures, data tables, or databases 162 to store or otherwise retain information and/or data representative of the unique identifier associated with each respective one of the plurality of VMs 112 and the data transfer rate limit associated with the respective VM. In some implementations, the data store 162 may include all or a part of the data store 172 in the control plane circuitry 170 (i.e., the traffic control circuitry 160 and the control plane circuitry 170 may share all or a portion of a common data store, data structure, data table, or database).

The traffic control circuitry 160 includes counter circuitry 330 having one or more counter circuits 332 capable of counting the output data packets generated by the offload circuits 150A-150n for each respective one of the plurality of VMs 112. In embodiments, the traffic control circuitry 160 includes additional circuitry and/or logic capable of converting output data packet count information for each of the plurality of VMs 112 to data transfer rate information for each of the plurality of VMs 112. In embodiments, the traffic control circuitry 160 includes comparator or similar circuitry to determine or detect whether the data transfer rate for each of the plurality of VMs 112 has exceeded the data transfer rate limit associated with the respective VM 112. When the traffic control circuitry 160 detects a situation in which the data transfer rate of a VM 112 exceeds the data transfer rate limit associated with the respective VM 112, the traffic control circuitry 160 communicates the control output signal 164 to the memory queue(s) 142 associated with the respective VM 112 to selectively halt the flow of data from the respective memory queue(s) 142 to the offload circuits 150A-150n.

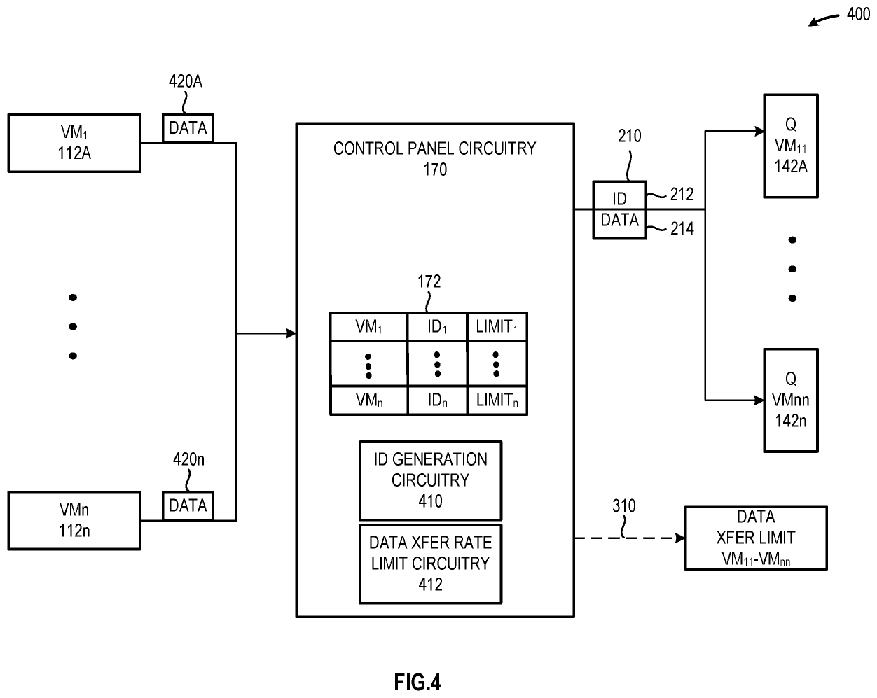

FIG. 4 depicts an input/output diagram of illustrative control plane circuitry 170 that includes the data store 172 and unique identifier generation circuitry 410, in accordance with at least one embodiment described herein. As depicted in FIG. 3, when the control plane circuitry 170 receives notification of an instantiation of a new VM 112 (e.g., from the IOMMU), the unique identifier generation circuitry 410 generates a unique identifier that is then associated with the VM. Information and/or data representative of the unique identifier and the associated VM 112 is stored or otherwise retained in the data store, data structure, data table or database 172. In embodiments, the control plane circuitry 170 also includes data transfer rate limit determination circuitry 412. The data transfer rate limit determination circuitry 412 looks-up, retrieves, calculates or otherwise determines the respective data transfer rate limit for each of the plurality of VMs 112. In embodiments, the data transfer rate limit determination circuitry 412 dynamically updates the data transfer rate limit for each of at least some of the plurality of VMs 112. Such dynamic updates may be event driven, for example upon detecting the instantiation of a new VM 112 or the termination of an existing VM 112. Such dynamic updates to some or all of the data transfer rate limits may be time or clock-cycle driven such that the data transfer rate limits are updated on a periodic, aperiodic, intermittent, or continuous basis. In embodiments, the control plane circuitry 170 generates one or more output signals 310 containing information and/or data representative of the data transfer rate limit for each respective one of all or a portion of the plurality of VMs 112. In such embodiments, the control plane circuitry 170 communicates the one or more output signals 310 to the traffic control circuitry 160.

In embodiments, the control plane circuitry 170 receives packets 420A-420n containing data from the plurality of VMs 112. The control plane circuitry 170 then associates the previously generated unique identifier with each of the data packets 420 communicated by the respective VM 112 to the queue circuitry 140. In embodiments, the control plane circuitry 170 inserts or otherwise stores information and/or data representative of the unique identifier associated with a VM 112 in a header or field in the header of the data communicated by the respective VM 112 to the queue circuitry 140.

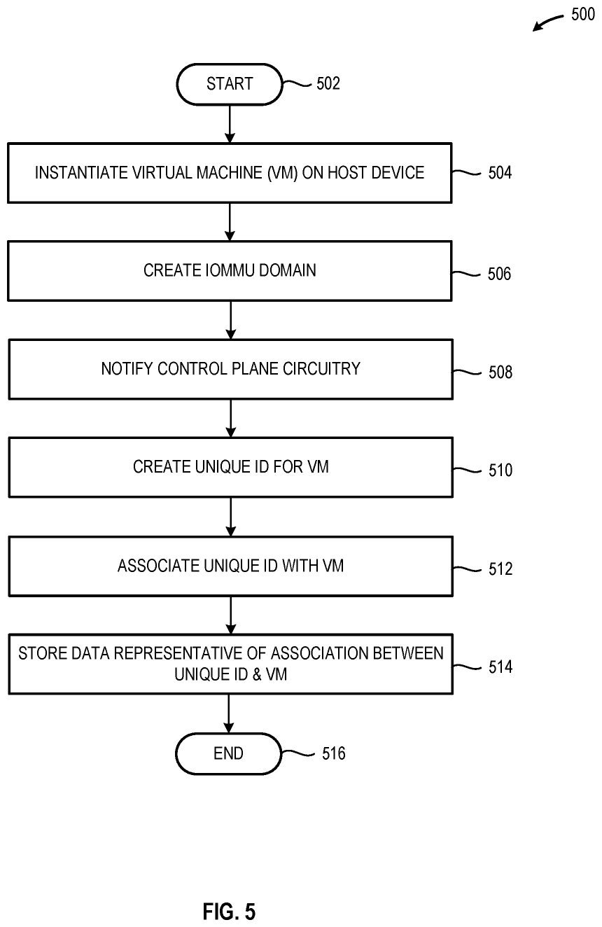

FIG. 5 is a high-level logic flow diagram of an illustrative method 500 of the control plane circuitry 170 creating and associating a unique identifier with a VM 112 upon instantiation of the VM 112, in accordance with at least one embodiment described herein. The method commences at 502.

At 504, a hypervisor or similar instantiates a new VM 112 on a host device 110 coupled to the network interface circuitry 120.

At 506, an input-output memory management unit (IOMMU) domain is created for use by the newly instantiated VM 112. The IOMMU maps the virtual memory addresses for the newly instantiated VM to host system physical memory addresses.

At 508, the control plane circuitry 170 receives notification of the instantiation of the new VM 112. In embodiments, the notification may occur as a direct or indirect result of the IOMMU memory mapping process.

At 510, the control plane circuitry 170 generates a unique identifier for the newly instantiated VM 112. In embodiments, identifier generation circuitry 412 included in the control plane circuitry 170 generates the unique identifier for the newly instantiated VM 112.

At 512, the control plane circuitry 170 creates an association between the unique identifier and the newly instantiated VM 112. This unique identifier is then subsequently used to route data packets from the VM 112 to the memory queue(s) 142 assigned to the VM 112. This unique identifier is also subsequently used associate a data transfer rate with the VM 112.

At 514, the control plane circuitry 170 causes a storage or retention of information and/or data representative of the association between the VM 112 and the unique identifier generated for the VM 112 by the control plane circuitry 170 in one or more data stores, data structures, data tables, or databases 172. In embodiments, the traffic control circuitry 160 may access all or a portion of the information and/or data stored or otherwise retained in the in one or more data stores, data structures, data tables, or databases 172. In embodiments, the control plane circuitry 170 pushes all or a portion of the information and/or data stored or otherwise retained in the one or more data stores, data structures, data tables, or databases 172 to the traffic control circuitry 160 on a periodic, aperiodic, intermittent, or continuous basis. In embodiments, the traffic control circuitry 160 pulls all or a portion of the information and/or data stored or otherwise retained in the one or more data stores, data structures, data tables, or databases 172 on a periodic, aperiodic, intermittent, or continuous basis. The method 500 concludes at 516.

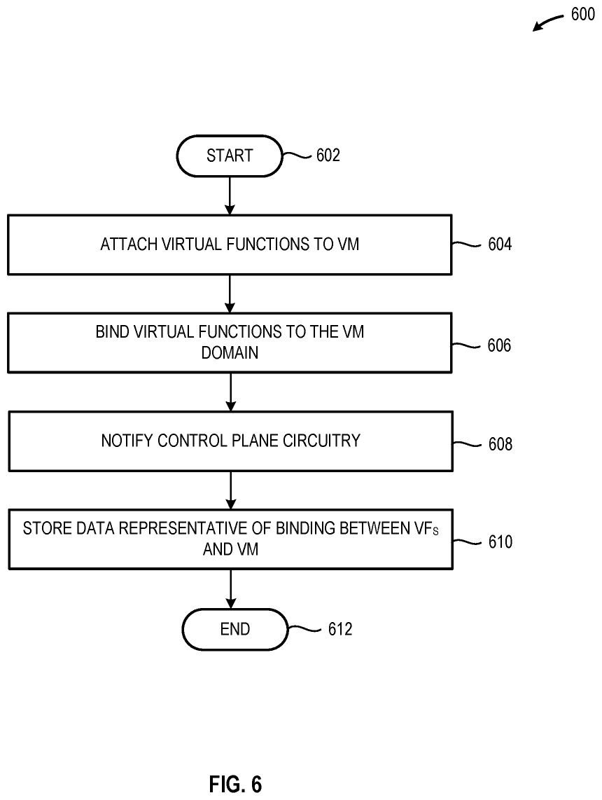

FIG. 6 is a high-level logic flow diagram of an illustrative method 600 of detecting the attachment of SR-IOV virtual functions (VFs) to a newly instantiated VM 112, in accordance with at least one embodiment described herein. The method 600 may be used in conjunction with the VM instantiation method 500 described in detail above with regard to FIG. 5. The method 600 commences at 602.

At 604, one or more SR-IOV VFs are attached to a VM 112 being executed on a host device 110. The one or more SR-IOV VFs may include but are not limited to: local area network access; remote direct memory access; storage device access; encryption/decryption engine access; acceleration engine access; and similar.

At 606, the host binds the VFs attached the VM 112 to the unique identifier assigned by the control plane circuitry 170 to the VM 112. In embodiments, the hypervisor executed by the host binds the VFs attached the VM 112 to the unique identifier assigned by the control plane circuitry 170 to the VM 112.

At 608, the host notifies the control plane circuitry 170 of the VFs to which the VM 112 has been bound. In embodiments, the hypervisor executed by the host 110 notifies the control plane circuitry 170 of the VFs to which the VM 112 has been bound.

At 610, the control plane circuitry 170 stores data representative of the VFs to which the VM 112 has been bound. In embodiments, the information and/or data representative of the VFs to which the VM 112 has been bound may be stored or otherwise retained in the in the one or more data stores, data structures, data tables, or databases 172. The binding between the VFs and the VM 112 determines the offload circuits 150A-150n to which the VM 112 has access. In embodiments, each of the plurality of VMs 112A-112n have access to each of the plurality of offload circuits 150A-150n. In other embodiments, each of the plurality of VMs 112A-112n have access to all or a portion of the plurality of offload circuits 150A-150n. The method 600 concludes at 612.

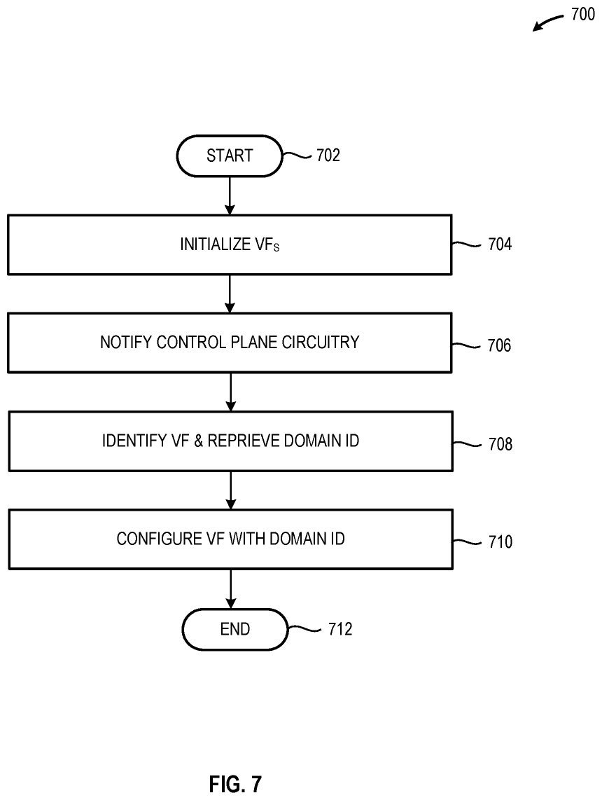

FIG. 7 is a high-level logic flow diagram of an illustrative method 700 of configuring the network interface circuitry 120 hardware resources for use by the VM 112, in accordance with at least one embodiment described herein. The method 700 may be used in conjunction with either or both, the VF detection method described in detail above with regard to FIG. 6 and/or the VM instantiation method 500 described in detail above with regard to FIG. 5. The method 700 commences at 702.

At 704, the VM device drive initializes the VFs attached to the VM 112.

At 706, the control plane circuitry 170 receives information and/or data indicative of the initialization of the VFs attached to the VM 112.

At 708, the control plane circuitry 170 identifies the VF and retrieves the unique identifier assigned by the control plane circuitry 170 to the VM 112 domain identifier.

At 710, the control plane circuitry 170 configures the VF hardware resources (I/O, memory queue(s) 142, etc.) with the unique identifier assigned by the control plane circuitry 170 to the VM as metadata. The method 700 concludes at 712.

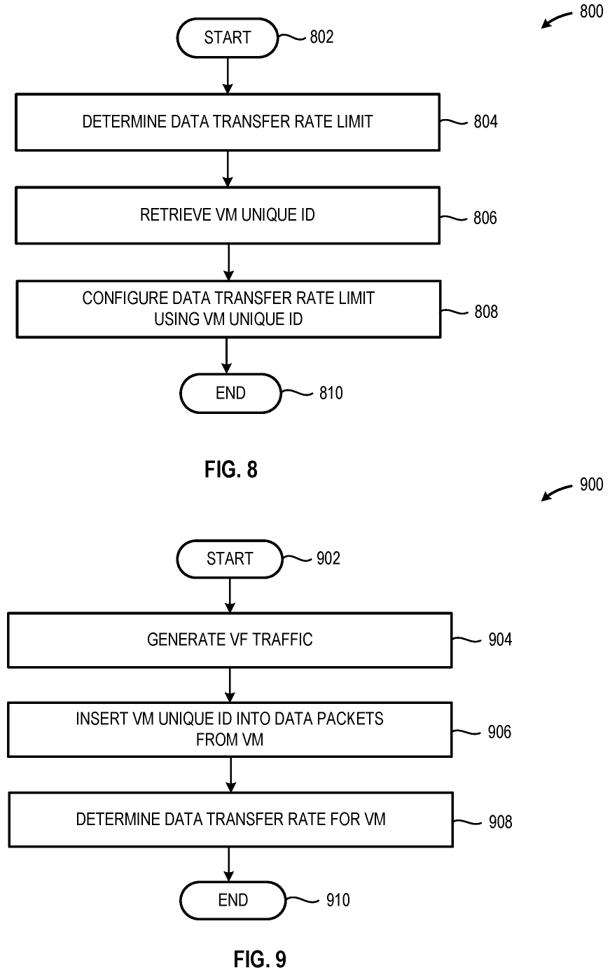

FIG. 8 is a high-level logic flow diagram of an illustrative method 800 of determining a data transfer rate limit for the VM 112, in accordance with at least one embodiment described herein. The method 800 may be used in conjunction with any of: the VF hardware resource configuration method described in detail above with regard to FIG. 7, the VF detection method described in detail above with regard to FIG. 6 and/or the VM instantiation method 500 described in detail above with regard to FIG. 5. The method 800 commences at 802.

At 804, the VM 112 receives a data transfer rate limit—the data transfer rate limit is based, at least in part, on the data transfer rate from the network interface circuitry 120 to the network 190. In embodiments, the control plane circuitry 170 determines the data transfer rate limit. In other embodiments, the traffic control circuitry 160 determines the data transfer rate limit. In embodiments, the data rate transfer limit may be determined upon initialization of the VM 112 and maintained at a fixed value for the life of the VM 112. In other embodiments, the data rate transfer limit may be determined upon initialization of the VM 112 and adjusted throughout all or a portion of the life of the VM 112 on a periodic, aperiodic, intermittent, continuous, or event-driven basis.

At 806, the control plane circuitry 170 and/or the traffic control circuitry 160 obtains, looks-up, or otherwise receives the unique identifier assigned to the VM 112 by the control plane circuitry 170.

At 808, the determined data transfer rate limit for the VM 112 is associated with the unique identifier assigned to the VM 112 by the control plane circuitry 170. In embodiments information and/or data representative of the determined data transfer rate limit and the unique identifier assigned to the VM 112 by the control plane circuitry 170 may be stored in at least one of: the data store 172 in the control plane circuitry 170 and/or the data store 162 in the traffic control circuitry 160. The method concludes at 810.

FIG. 9 is a high-level logic flow diagram of an illustrative method 900 of rate limiting the data flow from a VM 112 through the offload circuits 150A-150n, in accordance with at least one embodiment described herein. The method 900 may be used in conjunction with any of: the data transfer rate limit determination method 800 described in detail above with regard to FIG. 8, the VF hardware resource configuration method 700 described in detail above with regard to FIG. 7, the VF detection method 600 described in detail above with regard to FIG. 6 and/or the VM instantiation method 500 described in detail above with regard to FIG. 5. The method 900 commences at 902.

At 904, the VM 112 generates and communicates one or more data packets to the network interface circuitry 120. At least a portion of the one or more data packets include a VF that includes processing by an offload circuit 150.

At 906, the data packets are received at the network interface circuitry 120. In embodiments, the control plane circuitry 170 inserts information and/or data representative of the unique identifier assigned to the VM 112 into the header of each data packet prior to the packets being queued by the memory queue 142 associated with the VM 112.

At 908, the traffic control circuitry 160 determines the data transfer rate for the VM 112 by counting or otherwise determining an aggregate data transfer rate for the VM 112 through the plurality of offload circuits 150A-150n. Thus, traffic from the VM 112 through all of the offload circuits 150A-150n is included in the aggregate data transfer rate for the VM 112. The traffic control circuitry 160 compares the aggregate data transfer rate of the VM 112 through all of the offload circuits 150A-150n with the data transfer rate limit assigned to the VM 112 and stored in the data store 162. If the aggregate data transfer rate from the VM 112 exceeds the data transfer rate limit assigned to the VM 112, the traffic control circuitry 160 selectively limits the flow of data packets from the VM 112 to the memory queue(s) 142 associated with the VM. The method 900 concludes at 910.

While FIGS. 5 through 9 illustrate operations according to an embodiment, it is to be understood that not all of the operations depicted in FIGS. 5 through 9 are necessary for other embodiments. Indeed, it is fully contemplated herein that in other embodiments of the present disclosure, the operations depicted in FIGS. 5 through 9 and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software circuitry executed by a programmable control device.

Thus, the present disclosure is directed to systems and methods for rate limiting network traffic generated by virtual machines (VMs) having multiple attached SR-IOV virtual functions. The network interface circuitry includes a plurality of offload circuits, each performing operations associated with a specific VF. Each VM attached to network interface circuitry is assigned a unique identifier. The unique identifier associated with a VM is inserted into the header of data packets originated by the VM. The packets are queued using a dedicated memory queue assigned to the VM. The aggregate data transfer rate for the VM is determined based upon counting the data packets originated by the VM and processed across the plurality of offload circuits. If the aggregate data transfer rate exceeds a data transfer rate threshold, traffic control circuitry limits the transfer of data packets from the memory queue associated with the VM to the plurality of offload circuits.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for rate limiting network traffic generated by virtual machines (VMs) having multiple attached SR-IOV virtual functions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A network controller, comprising:
queue circuitry that includes a plurality of memory queues, each of the memory queues to receive data from a respective one of a plurality of virtual machines;
a plurality of offload circuits coupled to the queue circuitry; and
traffic control circuitry to:
determine a respective aggregate traffic flow from the plurality of offload circuits for each of the plurality of virtual machines; and
control the plurality of memory queues based on a comparison of the determined aggregate traffic flow from each respective one of the plurality virtual machines and a data transfer rate limit assigned to the virtual machine.

2. The network controller of claim 1, further comprising:
control plane circuitry to associate an identifier unique to a respective one of the plurality of virtual machines with the data received from the respective one of the plurality of machines.

3. The network controller of claim 2, the control plane circuitry to further:
determine the data transfer rate limit assigned to each respective one of the plurality of virtual machines.

4. The network controller of claim 2 wherein the traffic control circuitry further comprises:
at least one data table that includes data representative of the unique identifier associated with each of the plurality of virtual machines and the respective data transfer rate limit for each of the plurality of virtual machines.

5. The network controller of claim 2, the control plane circuitry to further:
assign the memory queue to receive data from a virtual machine responsive to detection of an initialization of the respective virtual machine.

6. The network controller of claim 2, the control plane circuitry to further:
associate the unique identifier with the respective one of the plurality of virtual machines responsive to detection of an instantiation of the respective one of the plurality of virtual machines.

7. The network controller of claim 1, further comprising:
host interface circuitry to receive data from each of plurality of virtual machines being executed by one or more host devices.

8. The network controller of claim 1, the traffic control circuitry to further:
responsive to a determination that the aggregate data transfer rate from a virtual machine exceeds the data transfer rate limit for the respective virtual machine, limit the flow of data from the memory queue that receives data from the respective virtual machine to the plurality of offload circuits to limit the data transfer rate of the respective virtual machine.

9. The network controller of claim 1, the traffic control circuitry to further:
responsive to a determination that the aggregate data transfer rate from a virtual machine exceeds the data transfer rate limit for the respective virtual machine, limit the flow of data from the respective virtual machine to the memory queue that receives data from the respective virtual machine to limit the data transfer rate of the respective virtual machine.

10. The system of claim 1 wherein the plurality of offload circuits includes two or more of: local area network offload circuitry; remote direct memory access circuitry; non-volatile store offload circuitry; encryption offload circuitry; or acceleration offload circuitry.

11. The network controller of claim 1 wherein the traffic control circuitry to further:
determine the data transfer rate limit assigned to each respective one of the plurality of virtual machines.

12. A non-transitory storage device that includes instructions, that when executed by network interface controller circuitry, cause the network interface controller circuitry to:
cause each of a plurality of memory queues to receive data from a respective one of a plurality of virtual machines; and
cause traffic control circuitry to:
determine a respective aggregate traffic flow from a plurality of offload circuits for each of the plurality of virtual machines; and
control the plurality of memory queues based on a comparison of the determined aggregate traffic flow from each respective one of the plurality virtual machines and a data transfer rate limit assigned to the virtual machine.

13. The non-transitory storage device of claim 12 wherein the instructions further cause the network interface controller circuitry to:
cause control plane circuitry to generate a unique identifier responsive to detection of an instantiation of a new virtual machine and associate the unique identifier with the new virtual machine.

14. The non-transitory storage device of claim 12 wherein the instructions further cause the network interface controller circuitry to:
cause control plane circuitry to determine the data transfer rate limit for each respective one of the plurality of virtual machines.

15. The non-transitory storage device of claim 12 wherein the instructions further cause the network interface controller circuitry to assign the memory queue to receive data from a virtual machine responsive to detection of an initialization of the respective virtual machine.

16. A network control system, comprising:
means for receiving data from each of a plurality of virtual machines at each a respective one of a plurality of memory queues;
means for determining a respective aggregate traffic flow from a plurality of offload circuits for each of the plurality of virtual machines; and
means for controlling the plurality of memory queues based on a comparison of the determined aggregate traffic flow from each respective one of the plurality virtual machines and a data transfer rate limit assigned to the virtual machine.

17. The system of claim 16, further comprising:
means for generating a unique identifier responsive to detection of an instantiation of a new virtual machine; and
means for associating the unique identifier with the new virtual machine.

18. The system of claim 16, further comprising:
means for determining the data transfer rate limit for each respective one of the plurality of virtual machines.

19. The system of claim 16, further comprising:
assigning the memory queue to receive data from a virtual machine responsive to detection of an initialization of the respective virtual machine.
